(19) United States
(12) Patent Application Publication
(10) Pub. No.: US 2014/0016327 A1
(43) Pub. Date: Jan. 16, 2014

(54) LIGHTING DEVICE AND METHOD OF MANUFACTURING THE SAME

(71) Applicants: Dong Hyun Lee, Seoul (KR); Dong Mug Seong, Seoul (KR); Beom Sun Hong, Seoul (KR); Jun Phill Eom, Seoul (KR)

(72) Inventors: Dong Hyun Lee, Seoul (KR); Dong Mug Seong, Seoul (KR); Beom Sun Hong, Seoul (KR); Jun Phill Eom, Seoul (KR)

(73) Assignee: LG INNOTEK CO., LTD., Seoul (KR)

(21) Appl. No.: 14/006,051

(22) PCT Filed: Apr. 3, 2012
(86) PCT No.: PCT/KR12/02484

§ 371 Date: Sep. 18, 2013

(30) Foreign Application Priority Data
Apr. 4, 2011 (KR) 10-2011-0030761

(51) Int. Cl. F21V 5/00; B29D 11/00

(52) U.S. Cl. CPC F21V 5/004; B29D 11/00865
USPC 362/330; 427/162

(57) ABSTRACT

Disclosed are a lighting device and a method of manufacturing the same, the lighting device includes a diffusion layer diffusing and emitting light incident from a light source; a bead layer adjacently formed to a light emitting surface of the diffusion layer, including a plurality of beads, and having a separation part formed in a region in which the plurality of beads are not present; and a condensing layer formed on the bead layer and condensing light transmitting the separation part to a predetermined portion. The exemplary embodiment of the present invention can form the separation part on the diffusion layer and the condensing layer by bonding beads to the diffusion layer and thus, can condense the light transmitting the diffusion layer to the condensing layer through the separation part, thereby easily reducing the UGR without disposing the separate barrier rib structure between the diffusion layer and the condensing layer.

### CROSS-REFERENCE TO RELATED APPLICATIONS

This application is the U.S. national stage application of International Patent Application No. PCT/KR2012/002484, filed Apr. 3, 2012, which claims priority to Korean Patent Application No. 10-2011-0030761, the disclosures of each of which are incorporated herein by reference in their entirety.

### TECHNICAL FIELD

The present invention relates to a lighting device and a method of the manufacturing the same.

### BACKGROUND ART

Lighting uses various types of light sources to brighten specific places for some purpose. In particular, lighting is mainly used to brighten surroundings at night or dark places.

FIG. 1 is a cross-sectional view of a lighting device in accordance with an embodiment of the related art. Referring to FIG. 1, the lighting device in accordance with the related art is configured to include a light source 10 and a lamp device 20. An example of the light source may include an incandescent lamp, an LED, a CCFL, or the like. Meanwhile, the lamp device 20 uses a louver (or reflector), or the like. In the lighting device, light emitted from a light source 10 may be directly propagated a person. As shown in FIG. 1, light of an angle represented by a dotted line may be propagated to a person, which causes visual displeasure to a person.

Therefore, the light source is mounted with the louver (or reflector) to inhibit light from being directly propagated to a person, thereby blocking light. However, the structure increases an overall size of the lighting device or makes a depth of a ceiling deeper so as to bury the lighting device, which leads to in an increase in installation cost and time of the lighting device. Further, a hot spot phenomenon that non-uniformly disperses light emitted from the light source 10 and partially concentrates light occurs. Recently, in order to reduce the hot spot and uniformly emit light, a diffusion layer is disposed at an outermost side of the lighting device. A structure of using the diffusion layer is shown in FIG. 2.

FIG. 2 is a cross-sectional view of a lighting device in accordance with another embodiment of the related art. Referring to FIG. 2, light emitted from a light source mounted in a lamp device 30 is emitted to the outside via a diffusion layer 40.

The reason for using the diffusion layer 40 at the outermost side of the lighting device is to reduce the hot spot of the light source 10 and uniformly emit light. However, the diffusion layer 40 used in flat lighting removes only the hot spot and therefore, the light of the angle represented by a dotted line as shown still gives an unpleasant feeling to a human eye. Unified glare rating (UGR) represents a degree of the unpleasant feeling.

The UGR is a method that unifies several methods for effectively evaluating unpleasant glare, which has been actually used since proposed by CIE in 1987. That is, the UGR is a quantified value by which a degree of an unpleasant feeling given to persons using lighting is represented, which is expressed by the following Equation.

$$UGR = 8 \cdot log [ \frac{0.25}{{L}_{Background}} ] {\sum }_{n} ( \frac{{L}^{2} ω}{{P}^{2}} )$$

In the above Equation, L_{Background} represents a luminance of background (value not including an effect of the light source), L is a luminance of a portion at which a light source within a field of vision of an observer emits light, ω represents a solid angle of a portion at which a light source within a field of vision of an observer emits light, and p represents a Guth's position index of each light source. Meanwhile, the solid angle ω is obtained from a light emitting area of the lighting device and a distance from a position of an observer to the lighting device. That is, ω=AP/γ2, where AP represents the light emitting area of the lighting device and γ represents a distance from an observer to a center of the light emitting area of the lighting device. The UGR couples characteristics of Einhorn and Hopkinson formulas and includes the Guth's position index, which may be considered as one accommodating advantages of practical main formulas for allowing the UGR to expect glare. In addition, a numerical value of a UGR evaluation grade that is appropriate for reading, writing, learning, computer works, or the like, is 19 or less. In order to see whether the lighting device in accordance with the related art meets the appropriate UGR, brightness according to the angle of light of the lighting device shown in FIG. 2 is shown in FIG. 3.

FIG. 3 shows a graph showing a light distribution of the lighting device in accordance with another embodiment of the related art at intensity for each angle. Referring to FIG. 3, the intensity of light within an angle of 60° or more represented by a dotted line is represented by left and right boxes based on angle 0° at which light is vertical past the diffusion layer. The value within the left and right box is proportional to the UGR. Referring to the numerical value within the box, the UGR value of the lighting device in which the diffusion layer 110 is formed is derived as numerical values of 20.3 and 20.9 at left and right sides, that is, −90° to −45° and 45° to 90°, respectively.

### DISCLOSURE

### Technical Problem

Most of the currently used indoor lamps use the reflector or the louver and the lamp is completely buried so as to reduce the angle of light diffused to a wide area that affects the UGR. In this case, however, the spatial restriction, such as the increase in the size of the lamp, the expansion of the installation area, or the like, is involved due to the louver, the reflector, the buried lamp, or the like.

Therefore, the related art may use the diffusion layer to reduce the effect of the hot spot but is not yet suitable for the UGR standard of 19 or less.

### Solution to Problem

An embodiment of the present invention is directed to a lighting device capable of reducing UGR while removing hot spot.

In accordance with an exemplary embodiment of the present invention, a lighting device, comprising: a diffusion layer emitting light incident from a light source; a bead layer adjacently formed to a light emitting surface of the diffusion layer, including a plurality of beads, and having a separation part formed in a region in which the plurality of beads are not present; a condensing layer formed on the bead layer and condensing light passing through the separation part.

In accordance with still another exemplary embodiment of the present invention, a method of manufacturing a lighting device includes: preparing a diffusion layer emitting light incident from a light source; forming a bead layer in such a manner to include a plurality of beads on the diffusion layer, and include a separation part in a region in which the plurality of beads are not present; and including a condensing layer condensing light passing through the separation part on the bead layer.

### Advantageous Effects

The exemplary embodiments of the present invention can form the separation part on the diffusion layer and the condensing layer by bonding beads to the diffusion layer and thus, can condense the light transmitting the diffusion layer to the condensing layer through the separation part, thereby easily reducing the UGR without disposing the separate barrier rib structure between the diffusion layer and the condensing layer. In addition, the exemplary embodiment of the present invention can use the condensing layer on which the pattern is formed to condense downwardly the light transmitting the separation part, thereby more reducing the UGR.

### BRIEF DESCRIPTION OF THE DRAWINGS

FIG. 1 is a cross-sectional view of a lighting device in accordance with an embodiment of the related art.

FIG. 2 is a cross-sectional view of a lighting device in accordance with another embodiment of the related art.

FIG. 3 shows a graph showing a light distribution of the lighting device in accordance with another embodiment of the related art at intensity for each angle.

FIG. 4 is a cross-sectional view of a lighting device in which a separation part is formed in accordance with an exemplary embodiment of the present invention.

FIG. 5 is a diagram showing a diffusion layer having a bead layer formed thereon in accordance with the exemplary embodiment of the present invention.

FIG. 6 is a cross-sectional view of a lighting device in which a separation part is formed in accordance with another exemplary embodiment of the present invention.

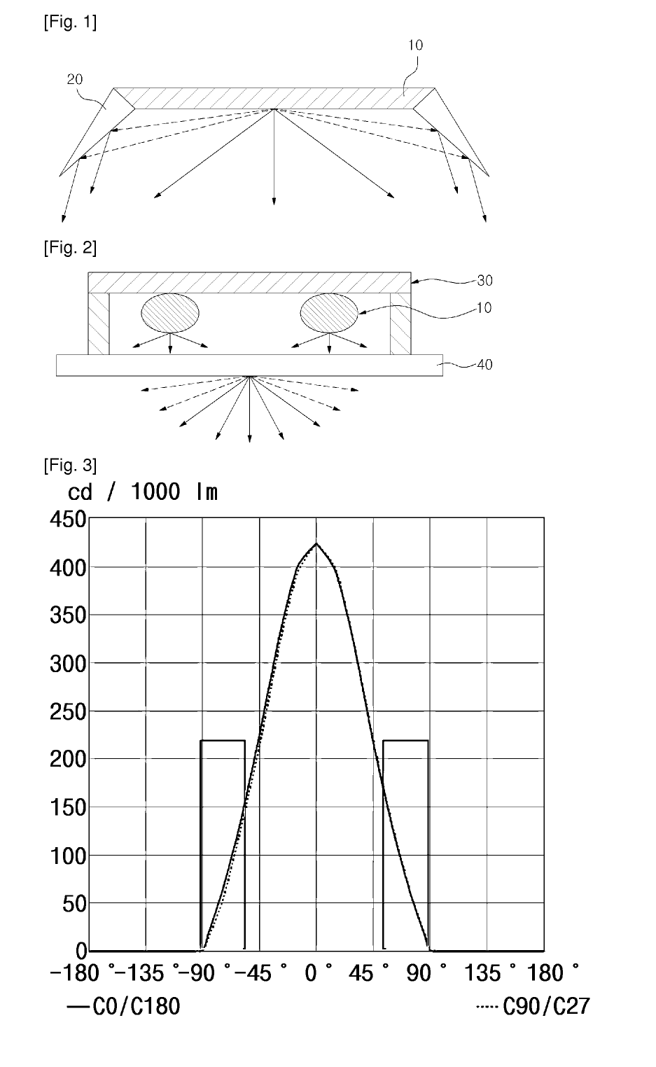

### MODE FOR INVENTION

Hereinafter, a lighting device in accordance with an exemplary embodiment of the present invention will be described in detail with reference to the accompanying drawings. Further, when it is determined that the detailed description of the known function or components may obscure the gist of the present invention, the detailed description thereof will be omitted. Therefore, a shape of each component shown in the drawings may be exaggerated so as to elucidate the description of the present invention.

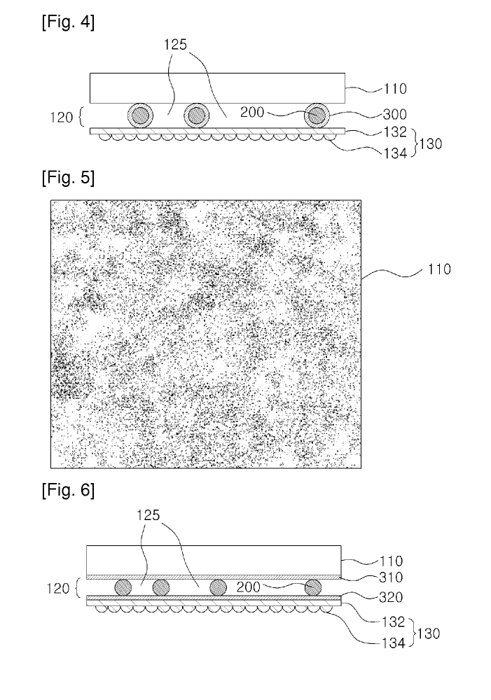

FIG. 4 is a cross-sectional view of a lighting device in which a separation part is formed in accordance with an exemplary embodiment of the present invention.

Referring to FIG. 4, a lighting device in accordance with an exemplary embodiment of the present invention is configured to include a diffusion layer 110, a bead layer 120, and a condensing layer 130. In detail, the diffusion layer 110 may be implemented as a sheet or a substrate or in accordance with another exemplary embodiment of the present invention, may be implemented by bonding the sheet to the substrate. The diffusion layer 110 diffuses and emits light incident through one surface thereof. The bead layer 120 is adjacently formed to a surface to which the light from the diffusion layer 110 is emitted.

The bead layer 120 is formed by bonding many beads 200 to a light emitting surface of the diffusion layer 110. The beads 200 is applied or coated by an adhesive material 300 so as to be bonded to the light emitting surface of the diffusion layer 110. In other words, the adhesive material 300 is coated on the beads 200 and then, the beads 200 are provided on the light emitting surface of the diffusion layer 110, such that the bead layer 120 may be formed on the diffusion layer 110.

In accordance with another exemplary embodiment of the present invention, the beads 200 of the bead layer 120 may be formed by an adhesive. In this case, the beads 200 do not need to be coated on the bead layer 120 by the adhesive material. To this end, the adhesive is sprayed on the light emitting surface of the diffusion layer 110 by a spray method. In addition to the spray method, the adhesive may be provided on the diffusion layer 110 or the condensing layer 130 by using a tip method, a pattern roll or plate method, a silk screen method, a mask method, or the like.

Further, the adhesive that is a material of the beads is made of a transparent or translucent material so that light transmitting a diffusion sheet or a diffusion plate transmits the beads 200. Further, the beads 200 may have a spherical shape, for example, a water drop shape due to a stress of the adhesive that is a fluid. The beads 200 having the water drop shape have a diameter of 500 μm or less, preferably, a diameter of 100 μm or less.

FIG. 5 is a diagram showing a diffusion layer having a bead layer formed thereon in accordance with the exemplary embodiment of the present invention.

Referring to FIG. 5, the beads 200 on which an adhesion liquid is smeared are applied to the diffusion layer 110 that is configured of the diffusion sheet or the diffusion plate. The beads 200 coated by the adhesive material 300 are sprayed on the surface of the diffusion sheet or the diffusion plate forming the diffusion layer 110, such that the bead layer 120 may be formed on the diffusion layer 110.

The beads 200 may be preferably provided in an area of 70% or less among the overall area of the diffusion layer 110. That is, an area in which the beads 200 are not present on the diffusion layer 110, that is, an area of an area gap 125 may preferably be 30% or more of the overall area of the diffusion layer 110. In this case, the size and area of the separation part 125 can be controlled by controlling the size or number of beads 200. Further, the size of the beads 200 may also be uniform and non-uniform.

In addition, a sheet, such as the condensing sheet, or the like, is disposed on the bead layer 120 to form the condensing layer 130, such that the separation part 125 is formed on the bead layer 120 by the beads 200. Describing in detail, the beads 200 serve as a spacer between the diffusion layer 110 and the condensing layer 130 to form the separation part 125 in a region in which beads 200 are not present. The separation part 125 is formed by being closed by the beads 200, the diffusion layer 110, and the condensing layer 130.

Further, the condensing layer 130 serves to condense light transmitting the separation part 125 to a predetermined portion to which light is emitted. To this end, the condensing layer 130 may be configured of a body part 132 having the bead layer 120 contacting one surface thereof and a pattern part 134 formed on the other surface of the body part 132. The body part 132 may use a sheet or a substrate and may also be used by bonding the sheet to the substrate. A shape of the pattern part 134 may also have a micro lens array shape like the left and may also have a prism shape like the right. Further, the shape of the pattern part may have a single cylindrical lens shape, or the like, or a mixing shape thereof in addition to this.

The shape of the pattern part 134 serves to refract light transmitting the separation part 125 once again while condensing light, thereby controlling the UGR.

Therefore, when the lamp is mounted on the diffusion layer 110 as shown in FIG. 2, the light emitted from the lamp transmits the diffusion layer 110 and is incident to the condensing layer 130 through the separation part 125.

As described above, the light transmitting only the separation part 125 and/or the light transmitting the separation part 125 are/is incident to the condensing layer 130 and are/is refracted according to the pattern 134 of the condensing layer 130 so as to be condensed. In this case, a refractive index of the condensing layer 130 may preferably be higher than refractive index 1 of air within the separation part 125 so that the light transmitting the separation part 125 is refracted downwardly. Therefore, the lighting device in accordance with the exemplary embodiment of the present invention primarily reduces the glare by the bead layer 120 and secondarily reduces the glare by the condensing layer 130, such that it can meet the appropriate UGR.

Hereinafter, a method for fabricating a lighting device in accordance with the exemplary embodiment of the present invention will be described.

A sheet or a substrate for the diffusion layer 110 is first prepared. Unlike this, the diffusion layer 110 is formed by bonding the sheet to the substrate. Thereafter, the adhesive 300 is coated or applied on the beads 200. Further, the beads 200 to which the adhesive 300 is applied are provided to the sheet or the substrate for the diffusion layer 110 to bond the beads 200 to which the adhesive 300 is applied to the sheet or the substrate, such that the bead layer 120 is formed. In this case, the beads 220 are provided on the diffusion layer 110 so that the area in which the beads 200 are not present on the diffusion layer 110 is 30% or more of the overall area of the diffusion layer 110. Next, the sheet, such as the condensing sheet, or the like, is disposed on the bead layer 120, such that the condensing layer 130 is formed.

FIG. 6 is a cross-sectional view of a lighting device in which a separation part is formed in accordance with another exemplary embodiment of the present invention.

Referring to FIG. 6, a lighting device in accordance with another exemplary embodiment of the present invention is configured to include the diffusion layer 110, the bead layer 120, the condensing layer 130, and adhesive layers 310 and 320. Similar to the exemplary embodiment of the present invention, the diffusion layer 110 may be implemented by a sheet or a substrate and diffuses light incident through one surface thereof and emits light through the other surface thereof.

A first adhesive layer 310 is formed on the surface to which the light from the diffusion layer 110 is emitted. The first adhesive layer 310 may be made of an adhesive material having adhesion. In addition, the bead layer 120 including the plurality of beads 200 is disposed on the first adhesive layer 310. The plurality of beads 200 may be fixed to the first adhesive layer 310 by the adhesion of the first adhesive layer 310.

Further, the sheet, such as the condensing sheet, or the like, is disposed on the bead layer 120, such that the condensing layer 130 is formed. In this case, the beads 200 of the bead layer 120 may further include a second adhesive layer 320 so as to be fixed to the condensing layer 130. That is, one surface of the condensing layer 130 contacting the beads 200 may be provided with the second adhesive layer 320. Therefore, the bead layer 120 is provided with the separation part by the beads 200.

Similar to the exemplary embodiment of the present invention, the beads 200 serve as the spacer between the diffusion layer 110 and the condensing layer 130 to form the separation part 125 in the region in which the beads 200 are not present. The separation part 125 is formed by a space closed by the beads 200, the diffusion layer 110, and the condensing layer 130.

Further, the condensing layer 130 serves to condense light transmitting the separation part 125 to a predetermined portion to which light is emitted. To this end, the condensing layer 130 may be configured of the body part 132 having the bead layer 120 contacting one surface thereof and the pattern part 134 formed on the other surface of the body part 132. The body part 132 may use a sheet or a substrate and may also be used by bonding the sheet to the substrate. The shape of the pattern part 134 may also have the micro lens array shape like the left and may also have the prism shape like the right. Further, the shape of the pattern part may have only the single cylindrical lens shape, or the like, or the mixing shape thereof, in addition thereto.

The shape of the pattern part 134 serves to refract light transmitting the separation part 125 once again while condensing light, thereby controlling the UGR.

Similar to the exemplary embodiment of the present invention, when the lamp is mounted on the diffusion layer 110 as shown in FIG. 2, the light emitted from the lamp transmits the diffusion layer 110 and is incident to the condensing layer through the separation part 125.

In this case, the first adhesive layer 310 and the second adhesive layer 320 may refract light. Therefore, a material of the first adhesive layer 310 and the second adhesive layer 320 may be a material that can refract light.

Hereinafter, a method for fabricating a lighting device in accordance with another exemplary embodiment of the present invention will be described.

The sheet or the substrate for the diffusion layer 110 is first prepared. Unlike this, the diffusion layer 110 is formed by bonding the sheet to the sheet. Next, the adhesive is applied to the sheet or the substrate for the diffusion layer 110 to form the first adhesive layer 310. That is, the first adhesive layer 310 is formed by coating or applying the adhesive on the sheet or the substrate.

Thereafter, the beads 200 are provided on the sheet or the substrate for the diffusion layer 100 to bond the beads 200 to the sheet or the substrate. In this case, the beads 220 are provided on the diffusion layer 110 so that the area in which the beads 200 are not present on the diffusion layer 110 is 30% or more of the overall area of the diffusion layer 110. Thereafter, the adhesive is provided on the sheet for the condensing layer 130 such as the condensing sheet to form the second adhesive layer 320. In other words, the second adhesive layer 320 is formed by coating or applying the adhesive on the condensing sheet. Next, the condensing sheet is bonded to the beads so as to bond the beads 200 to the second adhesive layer 320. In accordance with the exemplary embodiment of the present invention, the beads are bonded to the diffusion layer to form the separation part on the diffusion layer and the condensing layer, such that the light transmitting the diffusion layer is condensed to the condensing layer through the separation part, thereby easily reducing the UGR without disposing the separate barrier rib structure between the diffusion layer and the condensing layer. In addition, the exemplary embodiment of the present invention can use the condensing layer on which the pattern is formed to condense downwardly the light transmitting the separation part, thereby more reducing the UGR.

The detailed description of the present invention as described above describes the detailed exemplary embodiments.

The exemplary embodiments of the present invention can form the separation part on the diffusion layer and the condensing layer by bonding beads to the diffusion layer and thus, can condense the light transmitting the diffusion layer to the condensing layer through the separation part, thereby easily reducing the UGR without disposing the separate barrier rib structure between the diffusion layer and the condensing layer. In addition, the exemplary embodiment of the present invention can use the condensing layer on which the pattern is formed to condense downwardly the light transmitting the separation part, thereby more reducing the UGR.

While the present invention has been described with respect to the specific embodiments, it will be apparent to those skilled in the art that various changes and modifications may be made without departing from the spirit and scope of the invention as defined in the following claims.

1-15. (canceled)

16. A lighting device, comprising:
a diffusion layer emitting light incident from a light source;
a bead layer adjacently formed to a light emitting surface of the diffusion layer, including a plurality of beads, and having a separation part formed in a region in which the plurality of beads are not present; and
a condensing layer formed on the bead layer and condensing light passing through the separation part.

17. A lighting device, comprising:
a diffusion layer emitting light incident from a light source;
a bead layer including a plurality of beads on the diffusion layer, and having a separation part formed in a region in which the plurality of beads are not present;
a first adhesive layer included between the diffusion layer and the bead layer; and
a condensing layer formed on the bead layer and condensing light passing through the separation part.

18. The lighting device of claim 16, wherein the plurality of beads are coated with an adhesive material.

19. The lighting device of claim 18, wherein the diffusion layer and the bead layer are partially adhered to each other by the adhesive material.

20. The lighting device of claim 16, wherein a light refractive index of the condensing layer is 1.0 or more.

21. The lighting device of claim 17, wherein a light refractive index of the condensing layer is 1.0 or more.

22. The lighting device of claim 16, wherein the diffusion layer or the condensing layer is a sheet or a substrate.

23. The lighting device of claim 17, wherein the diffusion layer or the condensing layer is a sheet or a substrate.

24. The lighting device of claim 16, wherein the condensing layer comprises: a body part, one surface of which comes into contact with the bead layer; and a pattern part formed on another surface of the body part.

25. The lighting device of claim 17, wherein the condensing layer comprises: a body part, one surface of which comes into contact with the bead layer; and a pattern part formed on another surface of the body part.

26. The lighting device of claim 24, wherein the pattern part is configured of at least one of a micro lens, a cylindrical lens, and a prism lens.

27. The lighting device of claim 25, wherein the pattern part is configured of at least one of a micro lens, a cylindrical lens, and a prism lens.

28. The lighting device of claim 16, wherein an area of the separation part is 30% or more of an overall area of the diffusion layer.

29. The lighting device of claim 17, wherein an area of the separation part is 30% or more of an overall area of the diffusion layer.

30. The lighting device of claim 17, further comprising a second adhesive formed between the bead layer and the condensing layer.

31. A method of manufacturing a lighting device, comprising:
preparing a diffusion layer emitting light incident from a light source;
forming a bead layer in such a manner to include a plurality of beads on the diffusion layer, and to include a separation part in a region in which the plurality of beads are not present; and
including a condensing layer condensing light passing through the separation part on the bead layer.

32. The method of claim 31, wherein the forming of the bead layer comprises: coating the diffusion layer with an adhesive material; and including the plurality of beads on the coated adhesive material.

33. The method of claim 31, wherein the forming of the bead layer comprises forming the separation part in the region in which the plurality of beads are not present as the plurality of beads serve as a spacer.

34. The method of claim 32, wherein the including of the condensing layer comprises coating the bead layer with an adhesive material; and adhering the bead layer and the condensing layer to each other by the adhesive material.

35. The method of claim 34, wherein the including of the condensing layer comprises partially adhering the diffusion layer, the bead layer, and the condensing layer to each other by the adhesive material.

36. The method of claim 31, wherein the including of the condensing layer comprises forming a light refractive index of the condensing layer to be 1.0 or more.

37. The method of claim 31, wherein the diffusion layer or the condensing layer is composed of a sheet or a substrate.

38. The method of claim 31, wherein the including of the condensing layer comprises including a body part, one surface of which comes into contact with the bead layer; and forming a pattern part on another surface of the body part.

39. The method of claim 38, wherein the forming of the pattern part comprises forming the pattern part with at least one of a micro lens, a cylindrical lens, and a prism lens.

40. The method of claim 31, wherein the forming of the bead layer comprises forming an area of the separation part to be 30% or more of an overall area of the diffusion layer.
